(19) United States
(12) Patent Application Publication
(10) Pub. No.: US 2009/0141741 A1
(43) Pub. Date: Jun. 4, 2009

(54) METHOD AND APPARATUS FOR CONNECTING SENSOR NETWORK TO HETEROGENEOUS NETWORK

(75) Inventors: Bong Wan KIM, Daejeon-city (KR); Byeong Cheol Choi, Daejeon-city (KR); Eun Ju Lee, Daejeon-city (KR); Jae Hong Ruy, Daejeon-city (KR); Bong Soo Kim, Daejeon-city (KR); Cheol Sig Pyo, Daejeon-city (KR); Jong-Suk Chae, Daejeon-city (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon-city (KR)

(21) Appl. No.: 12/176,843

(22) Filed: Jul. 21, 2008

(30) Foreign Application Priority Data
Nov. 30, 2007 (KR) 10-2007-0123641

(51) Int. Cl. H04L 29/02

(52) U.S. Cl. 370/474

(57) ABSTRACT

Provided are a method and apparatus for connecting a sensor network to a heterogeneous network, in which an external network connected to the sensor network functions as a virtual personal area network (PAN) so that the same PAN address system is used between the sensor network and the external network by using a concept of a ‘virtual PAN’. According to the method and apparatus for connecting the sensor network to the heterogeneous network, a node of the sensor network can efficiently communicate with a node of the external network including the heterogeneous network by assigning the virtual PAN address to the node of the external network including the heterogeneous network without inserting any additional layer into the node of the sensor network.

### CROSS-REFERENCE TO RELATED PATENT APPLICATION

This application claims the benefit of Korean Patent Application No. 10-2007-0123641, filed on Nov. 30, 2007, in the Korean Intellectual Property Office, the disclosure of which is incorporated herein in its entirety by reference.

### BACKGROUND OF THE INVENTION

1. Field of the Invention

The present invention relates to a method and apparatus for connecting a sensor network to a heterogeneous network, and more particularly, to a method and apparatus for efficiently connecting a sensor network to an external network having an address system different from that of the sensor network.

According to the method and apparatus for connecting a sensor network to a heterogeneous network according to the present invention, the node of the sensor network can be connected to the external network including the heterogeneous network by efficiently designing an address system that is an important factor in terms of the communication efficiency of a node of the sensor network operating with limited resources.

The present invention is derived from a research project supported by the Information Technology (IT) Research & Development (R&D) program of the Ministry of Information and Communication (MIC) and the Institute for Information Technology Advancement (IITA) [2005-S-038-03, Development of UHF RF-ID and Ubiquitous Network Technology].

2. Description of the Related Art

By virtue of the development of communication technologies, a user can experience an environment in which his or her computer can be connected to a network anytime, anywhere, and to any device. This is referred to as a ubiquitous network environment. Research in the field of communication technologies has been conducted so that ubiquitous environments can be integrated into real life, and accordingly recent communication technologies have been developed.

The core technology of a ubiquitous environment is a sensor network system.

In order to realize the sensor network system, radio frequency identifications (RFIDs) are attached to all necessary devices, and detects information regarding surroundings of the devices (e.g., information regarding temperature, humidity, pollution, a crack, or the like), including basic information regarding recognition of things and the information is transferred to the sensor network system so as to be managed.

As a result, by allowing all devices to function in terms of computing and communicating, the sensor network system can embody an environment in which “anytime, anywhere and anything” communication can be realized.

In the sensor network system, a sensing device (i.e., a node) disposed at a predetermined location or unspecified location detects information regarding changes in geography, environment, society or the like, and transmits to the detected information to another sensing device adjacent to the sensing device or a cluster of sensing devices in which a plurality of sensing devices are grouped in a predetermined space, or finally transmits the detected information to a base station.

In a common mobile communication system, a mobile element and a base station transmit and receive data to and from each other. The mobile element and the base station transmit and receive data directly to and from each other, instead of via another mobile element or other nodes. However, the sensor network system uses other nodes when a node of the sensor network is to transmit data to a sink node.

FIG. 1 illustrates a configuration of a sensor network.

The sensor network includes a sink node and a plurality of sensor nodes.

Only one sink node is illustrated in FIG. 1, but the sensor network may include at least two sink nodes, according to the settings of a user.

The sensor node collects information regarding a target region set by a predetermined user.

The information regarding the target region collected by the sensor node refers to surrounding temperature and humidity, the movement of devices, the efflux of gases, and the like.

The sensor node transmits the information collected regarding the target region to the sink node.

The sink node receives the information transmitted by the sensor nodes included in the sensor network. A sensor node, which is positioned within a predetermined distance from the sink node, transmits data directly to the sink node.

However, a sensor node, which is not positioned within the predetermined distance from the sink node, transmits the collected data to sensor nodes adjacent to the sink node, instead of transmitting the data directly to the sink node.

By virtue of the recent development of information and communication technologies, communication network services are integrated between heterogeneous networks.

Conventional voice-oriented communication networks have been changing to inexpensive Internet telephone (VoIP) networks. A wired/wireless communication network has been being developed in pursuit of integration. Analog television (TV) has been being developed to become digital TV. Broadband and IPv6 have been being provided in the Internet.

A ubiquitous sensor network (USN) is a network in which a sensor network is connected to an IPv6-based broadband convergence network (BcN).

In order to complete the USN, a field regarding a sensor network needs to receive first attention.

Since only small amounts of data are transmitted and received by sensor nodes of the sensor network, and the data is infrequently formed, the amount of data communication is not great.

Thus, the small size of the sensor node does not affect the energy efficiency of the sensor node. When the sensor network operates alone, it is sufficient that an address system can indicate the maximum number of sensor nodes of the sensor network.

However, when the sensor network operates so as to be connected to an external network including a heterogeneous network, since the address system of the sensor network is different from that of the external network, overhead for transferring a control signal is increased, thereby increasing energy consumption.

When the sensor network is connected to a different kind of external network to interoperate with the heterogeneous network, sensor nodes of the sensor network needs to generate data packets so that the data packets are matched to an address system of the heterogeneous network, and transmit the data packets to the heterogeneous network.

Internet protocol version 4 (IPv4), which is a typical address system of the Internet, uses an address value occupying 32 bits, and Internet protocol version 6 (IPv6), which has been newly introduced in order to overcome a problem in terms of lack of spaces for address values in IPv4, uses an address value occupying 128 bits.

IPv4 or IPv6 uses an address value occupying a very large amount of bits, unlike in the case where the sensor network usually uses an address system in which an address value occupying 16 bits is provided in the same PAN.

Generally, the sensor nodes of the sensor network operate as a sensor operated by a small-sized battery.

Thus, in order to maintain and operate the sensor network over a long period of time, the sensor needs to use a technology for ensuring the economic use of its battery.

In order to increase energy efficiency, the amount and frequency of communication needs to be reduced. In this regard, the size of a portion regarding an address, included in a header of a data packet, needs to be reduced, and thus efficient communication can be performed in the sensor network.

Conventional technologies put emphasis on interoperation compared with transmission efficiency.

Representatively, a subdivision IPv6 over Low power Wireless Personal Area Networks (6LoWPAN) of the Internet Engineering Task Force (IETF) that is an Internet standardization organization, standardizes interoperation between the sensor network and IPv6.

The IETF has proposed a method of communicating with the sensor network by using a header formed by compressing a part of the IPv6 header.

The method using the header formed by compressing a part of the IPv6 header may be helpful in terms of interoperation. However, as a header having a new and different format has been introduced, sensor nodes of the sensor network need additionally to embody another communication layer for interpreting the header.

### SUMMARY OF THE INVENTION

The present invention provides a method and apparatus for connecting a sensor network to a heterogeneous network, in which an external network connected to the sensor network functions as a virtual personal area network (PAN)—that is, nodes of the sensor network communicate with nodes of the external network in the same way that the nodes of the sensor network communicate with nodes which are in other PAN of the sensor network—so that the same PAN address system is used between the sensor network and the external network by using a concept of a ‘virtual PAN’, thereby increasing the energy efficiency and the data transmission efficiency of the sensor network.

According to the method and apparatus, nodes of the sensor network which operate with limited resources can be connected to the external network including the heterogeneous network by designing an efficient address system, thereby increasing data transmission efficiency.

According to an aspect of the present invention, there is provided an apparatus for connecting a sensor network to a heterogeneous network, the apparatus including: a virtual personal area network (PAN) address generator assigning a virtual PAN address to a node of an external network; a PAN header generator generating a modified header, which includes the virtual PAN address, for controlling a data packet transmitted from the node of the external network to a node of the sensor network; an address mapping table used for storing an actual address of the node of the external network mapped to the virtual PAN address; a virtual PAN address searcher searching the address mapping table for the actual address of the node of the external network; and a header generator generating a modified header, which includes the actual address of the node of the external network, for controlling a data packet transmitted from the node of the sensor network to the node of the external network.

According to another aspect of the present invention, there is provided a method of connecting a sensor network to a heterogeneous network, the method comprising: assigning a virtual PAN address to a node of an external network; generating a modified header, which includes the virtual PAN address, for controlling a data packet transmitted from the node of the external network to a node of the sensor network, and transmitting the data packet with the modified header to the node of the sensor network; storing an actual address of the node of the external network mapped to the virtual PAN address in an address mapping table; searching the address mapping table for the actual address of the node of the external network; and generating a modified header, which includes the actual address of the node of the external network, for controlling a data packet transmitted from the node of the sensor network to the node of the external network and transmitting the data packet with the modified header which includes the actual address of the node of the external network to the node of the external network.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a configuration of a sensor network;

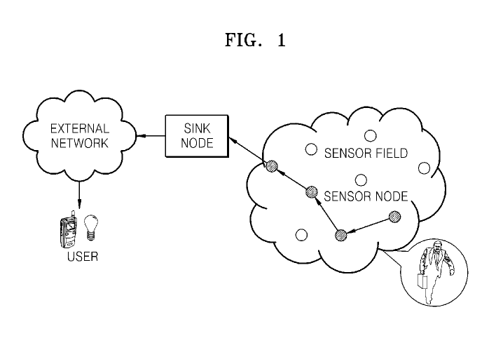

FIG. 2 illustrates a configuration in which a sensor network and an external IP (information provider) network including a heterogeneous network are connected via a gateway, according to an embodiment of the present invention;

FIG. 3 illustrates a configuration of an apparatus for connecting a sensor network to a heterogeneous network, according to an embodiment of the present invention; and

FIG. 4 illustrates flow charts of a method of connecting a sensor network to a heterogeneous network, according to an embodiment of the present invention.

### DETAILED DESCRIPTION OF THE INVENTION

Hereinafter, the present invention will be described in detail by explaining exemplary embodiments of the invention with reference to the attached drawings.

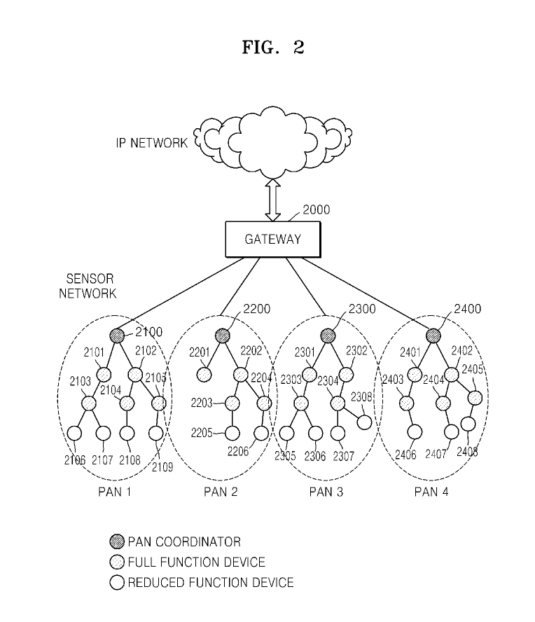

FIG. 2 illustrates a configuration in which a sensor network and an external IP (information provider) network including a heterogeneous network are connected via a gateway 2000, according to an embodiment of the present invention.

The sensor network includes many kinds of nodes, as illustrated in FIG. 2.

FIG. 2 illustrates a tree-based connection structure, and the sensor network includes four personal area networks (PANs) PAN1, PAN2, PAN3 and PAN4.

The PANs PAN1, PAN2, PAN3 and PAN4 include reduced function devices (RFDs) 2106 through 2109, 2205 and 2206, 2305 through 2308, and 2406 through 2408, each of which is a node having a limited function without a routing function, full function devices (FFDs) 2101 through 2105, 2201 through 2204, 2301 through 2304, and 2401 through 2405, each of which is a node having a routing function, and PAN coordinators 2100, 2200, 2300 and 2400 each of which coordinates predetermined RFDs and predetermined FFDs as one PAN.

The gateway 2000 functions as a path connecting the nodes of the sensor network to the external IP network when the nodes of the sensor network are to communicate with the external IP network.

In other words, the sensor network can communicate with the external IP network including the heterogeneous network via the gateway 2000.

When nodes of the sensor network communicate with each other, an address system providing an address value occupying a small amount of bits (e.g., PAN ID (16 bit)+short ID (16 bit)) is used due to a constraint in supplying power of the nodes, or the like.

On the other hand, in the Internet, address systems using internet protocol version 4 (IPv4) and internet protocol version 6 (IPv6) provide address values occupying sizes of 32 bits and 128 bits, respectively.

Likewise, since different address systems are used in the sensor network and the Internet, encapsulation, in which an address value for the other party is contained in a data packet to be transmitted, is used.

As a result, the encapsulation increases the size of a header of the data packet, thereby deteriorating transmission efficiency.

In order to solve the above problem, a method and an apparatus for connecting the sensor network to the heterogeneous network according to embodiments of the present invention are provided, wherein a virtual PAN ID is assigned to the external IP network and short IDs are assigned to the respective nodes included in the external IP network communicating with the sensor network.

The gateway 2000 connecting the sensor network to the external IP network assigns and converts the virtual PAN ID and the short IDs. According to the address system of the sensor network providing an address value of PAN ID (16 bit)+short ID (16 bit), an address of a node of the external IP network can be determined, and thus the sensor network can communicate with the external IP network, transmitting/receiving a data packet having a small-sized header without encapsulation.

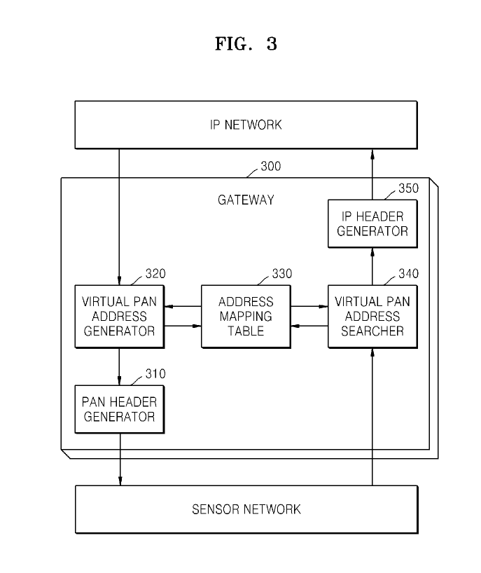

FIG. 3 illustrates a configuration of an apparatus for connecting a sensor network to a heterogeneous network, according to an embodiment of the present invention.

According to the current embodiment, the apparatus for connecting the sensor network to the heterogeneous network, that is, a gateway 300, does not perform a capsulizing operation of a data packet, that is, encapsulation or decapsulation, unlike in the case of a common gateway.

According to the current embodiment, the apparatus for connecting the sensor network to the heterogeneous network, that is, the gateway 300, includes a PAN header generator 310, a virtual PAN address generator 320, an address mapping table 330, a virtual PAN address searcher 340 and an IP header generator 350.

The virtual PAN address generator 320 assigns a virtual PAN address to a node of an external IP network.

In order to assign the virtual PAN address, a predetermined PAN ID indicating the external IP network is assigned to the node of the external IP network, and thus nodes of the sensor network can recognize that the node having the predetermined PAN ID is included in the external IP network.

One PAN ID may be assigned to the external IP network. Alternatively, various PAN IDs may be assigned to the external IP network so as to be used in the case where the sensor network frequently communicates with the external IP network.

The PAN header generator 310 generates a header, which includes the virtual PAN address, for controlling data transmitted from the external IP network to the node of the sensor network.

The address mapping table 330 performs mapping in which an actual address of the node of the external IP network and the virtual PAN address correspond to each other, and stores the actual address.

The virtual PAN address searcher 340 searches the address mapping table 330 so as to read an actual address of a node of the external IP network corresponding to a virtual PAN address contained in a data packet transmitted from the sensor network to the external IP network.

The IP header generator 350 generates a header for controlling data that is transmitted from the sensor network to the external IP network.

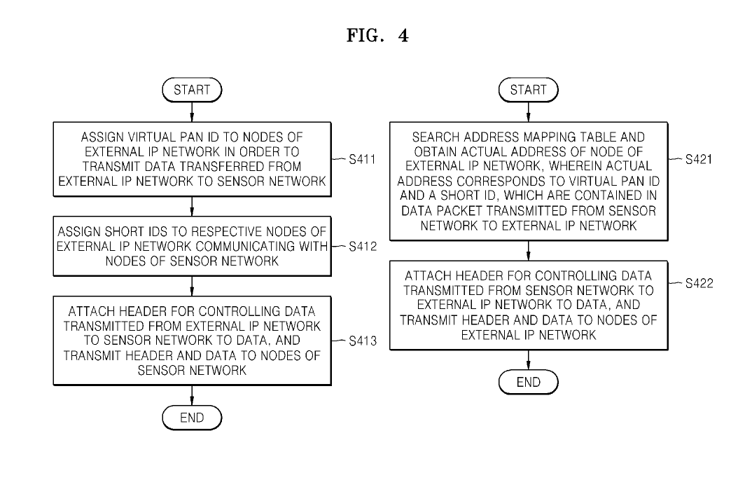

FIG. 4 illustrates flow charts of a method of connecting a sensor network to a heterogeneous network, according to an embodiment of the present invention.

Operation S411 through S413 illustrate a method of assigning an address when data is transmitted from an external IP network to a sensor network.

In order to transmit the data transferred from the external IP network to the sensor network, a virtual PAN ID is assigned to nodes of the external IP network (S411).

Short IDs are assigned to the respective nodes of the external IP network communicating with nodes of the sensor network (S412).

A header for controlling the data transmitted from the external IP network to the sensor network is attached to the data, and the data is transmitted to the sensor network (S413).

Operation S421 and S422 illustrates a method of assigning an address when data is transmitted from the sensor network to the external IP network.

The address mapping table 330 is searched so as to read an actual address of a node of the external IP network, wherein the actual address corresponds to a virtual PAN ID and a short ID, which are contained in a data packet transmitted from the sensor network to the external IP network (S421).

A header for controlling the data transmitted from the sensor network to the external IP network is attached to the data, and the data is transmitted to the external IP network (S422).

The invention can also be embodied as computer readable codes on a computer readable recording medium. The computer readable recording medium is any data storage device that can store data which can be thereafter read by a computer system.

Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

According to the method and apparatus for connecting the sensor network to the heterogeneous network according to the above embodiments of the present invention, the sensor network can assign an address to a node of the external IP network using the address system providing an address value of PAN ID (16 bit)+short ID (16bit), and thus the sensor network can communicate with the external IP network transmitting/receiving a data packet having a small-sized header without encapsulation.

According to the method and apparatus for connecting the sensor network to the heterogeneous network according to the above embodiments of the present invention, a node of the sensor network can efficiently transmit data to a node of the external IP network without inserting any additional layer into the node of the sensor network.

In addition, the method and apparatus can be applied to a sensor network of a general-purpose environment, and can increase the energy efficiency of a sensor node by reducing overhead with respect to data transmission.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. An apparatus for connecting a sensor network to a heterogeneous network, the apparatus comprising:
a virtual personal area network (PAN) address generator assigning a virtual PAN address to a node of an external network;
a PAN header generator generating a modified header, which includes the virtual PAN address, for controlling a data packet transmitted from the node of the external network to a node of the sensor network;
an address mapping table used for storing an actual address of the node of the external network mapped to the virtual PAN address;
a virtual PAN address searcher searching the address mapping table for the actual address of the node of the external network; and
a header generator generating a modified header, which includes the actual address of the node of the external network, for controlling a data packet transmitted from the node of the sensor network to the node of the external network.

2. The apparatus of claim 1, wherein the external network uses one address system selected from one of Internet protocol version 4 (IPv4) providing an address value occupying 32 bits and Internet protocol version 6 (IPv6) providing an address value occupying 128 bits.

3. The apparatus of claim 1, wherein the virtual PAN address generator simultaneously assigns a short address to the node of the external network.

4. The apparatus of claim 1, wherein the PAN header generator, the virtual PAN address generator, the address mapping table, the virtual PAN address searcher and the header generator are embodied in a gateway connecting the sensor network to the external network.

5. A method of connecting a sensor network to a heterogeneous network, the method comprising:
assigning a virtual PAN address to a node of an external network;
generating a modified header, which includes the virtual PAN address, for controlling a data packet transmitted from the node of the external network to a node of the sensor network, and transmitting the data packet with the modified header to the node of the sensor network;
storing an actual address of the node of the external network mapped to the virtual PAN address in an address mapping table;
searching the address mapping table for the actual address of the node of the external network; and
generating a modified header, which includes the actual address of the node of the external network, for controlling a data packet transmitted from the node of the sensor network to the node of the external network and transmitting the data packet with the modified header which includes the actual address of the node of the external network to the node of the external network.

6. The method of claim 5, further comprising:
assigning a short address to the node of the external network.
